(19) United States
(12) Patent Application Publication
(10) Pub. No.: US 2014/0227416 A1
(43) Pub. Date: Aug. 14, 2014

(54) CONTAINER WITH INCORPORATED JUICER

(71) Applicants: David Dennys Chitayat, Shanghai (CN); Heather Tomasetti, Shanghai (CN); Pieter Schouten, Berkeley, CA (US)

(72) Inventors: David Dennys Chitayat, Shanghai (CN); Heather Tomasetti, Shanghai (CN); Pieter Schouten, Berkeley, CA (US)

(73) Assignee: Genimex Jersey Ltd., Shanghai (CN)

(21) Appl. No.: 13/098,626

(22) Filed: May 2, 2011

Related U.S. Application Data
(60) Provisional application No. 61/332,684, filed on May 7, 2010.

(51) Int. Cl. A23N 1/00; A23L 2/04

(52) U.S. Cl. 426/489; 99/495

(57) ABSTRACT

A container facilitating addition of on-demand juice into the container without modal conversion of the container to activate a juicing accessory. A juicer-enabled container includes a base container having a closed surface wherein a portion of the closed surface defines an opening; a juicer adapted to engage the portion of the closed surface, the juicer including one or more juicing elements that extract a quantity of juice from an object interacting with the one or more juicing elements and further including one or more apertures communicating the quantity of juice into the base container; and a first closure, repeatedly engageable with and disengageable from the portion of the closed surface, sealing the opening while the juicer is engaged with the portion of the closed surface and while the juicer is engaged in a juice-extracting configuration.

### BACKGROUND OF THE INVENTION

The present invention relates generally to containers, and more specifically to a container having an integrated juicer for adding desired quantities of fresh juice into the container.

Marketing of certain cleaning solutions for such containers frequently promotes use of citrus juice in the solution. These solutions for are either pre-mixed and sold at retail or they are custom mixed at a location of use. A common type of container used in dispensing these cleaning solutions is a spray-bottle. The pre-mixed solution is either sold in a spray bottle or transferred into an existing spray bottle. The same is true for custom mixed cleaning solutions. The container may be sold empty or distributed with a solution pre-added.

For some cleaning solutions, a total quantity of juice used in the cleaning solution determines a “strength” of the cleaning solution. Without easy access to a juicer, users can be at a loss on how to easily add juice into a container, such as to strengthen the cleaning solution.

In other solutions, for example citrus juice beverages, a total juice quantity is an important element. Particularly for users desiring citrus juice beverages with fresh citrus juice, a container that facilitates on-demand production of the beverage by easily permitting on-demand addition of desired quantities of fresh citrus juice into the container is advantageous.

It has been known to provide containers with multi-modal accessories, that in one mode an accessory is converted from a storage mode or some other function into a temporary juicing mode. These containers require conversion and mode-change enable juicing. Further, the container is more complicated than it needs to be for an application focusing on a dedicated integrated juicing function.

What is needed is a container that facilitates addition of on-demand juice into the container without modal conversion of the container to activate a juicing accessory.

### BRIEF SUMMARY OF THE INVENTION

Disclosed is a container that facilitates addition of on-demand juice into the container without modal conversion of the container to activate a juicing accessory. A juicer-enabled container includes a base container having a closed surface wherein a portion of the closed surface defines an opening; a juicer adapted to engage the portion of the closed surface, the juicer including one or more juicing elements that extract a quantity of juice from an object interacting with the one or more juicing elements and further including one or more apertures communicating the quantity of juice into the base container; and a first closure, repeatedly engageable with and disengageable from the portion of the closed surface, sealing the opening while the juicer is engaged with the portion of the closed surface and while the juicer is engaged in a juice-extracting configuration.

A juicing method includes the steps of: (a) disengaging a first closure from a portion of a surface of a container, the portion of the surface defining an opening, wherein the first closure disengaging step reveals a juicer engaged with the portion of the surface with the juicer overlaying a reservoir of the container and the revealed juicer preconfigured into a juice-extracting configuration automatically available for juicing without reconfiguring the juicer; and (b) interacting an object with the juicer to extract juice into the reservoir.

There are many advantages to embodiments of the present invention. These advantages include an advantage in providing quick and easy quantities of pure juice. These and other advantages of the present invention will be evident upon a review of the application including the specification, drawing, and claims.

### BRIEF DESCRIPTION OF THE DRAWINGS

FIG. 1 is a perspective view of an assembled juice-extracting container;

FIG. 2 is a front view of the container shown in FIG. 1;

FIG. 3 is a left-side view of the container shown in FIG. 1, the right side being a minor image;

FIG. 4 is a top view of the container shown in FIG. 1;

FIG. 5 is a left-side view of the container shown in FIG. 1 disassembled to better illustrate the elements thereof;

FIG. 6 is a perspective view of an assembled juice-extracting container having a different configuration than the container of FIG. 1;

FIG. 7 is a front view of the container shown in FIG. 6, the back view being a minor image;

FIG. 8 is a left-side view of the container shown in FIG. 6, the right side being a minor image;

FIG. 9 is a top view of the container shown in FIG. 6;

FIG. 10 is a left-side view of the container shown in FIG. 6 disassembled to better illustrate the elements thereof;

FIG. 11 is a partial perspective view illustrating an interlock assembly for a juicer element; and

FIG. 12 is an exploded view detailing the interlock assembly of FIG. 11.

### DETAILED DESCRIPTION OF THE INVENTION

The present invention relates to a method, system and apparatus for a container that facilitates addition of on-demand juice into the container without modal conversion of the container to activate a juicing accessory. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

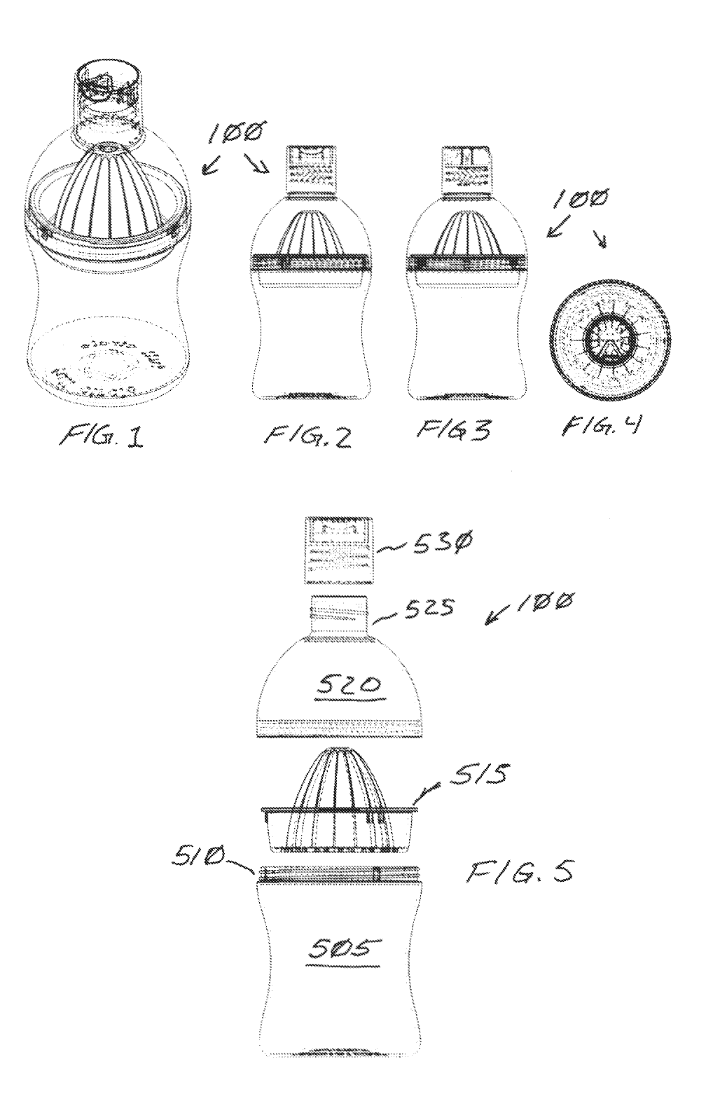

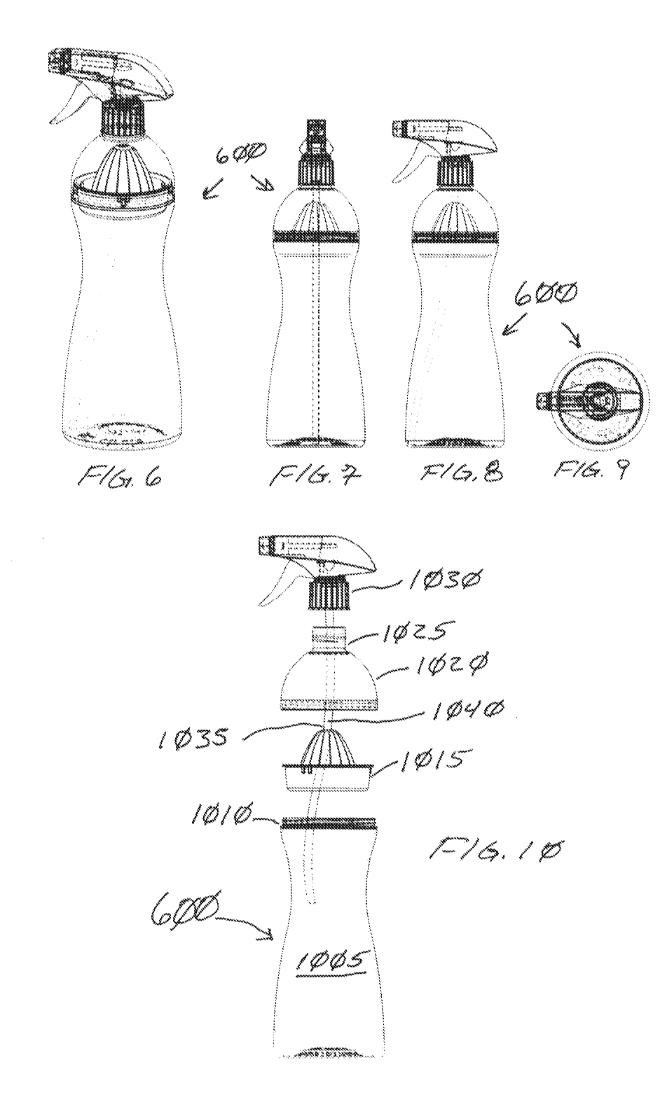

FIG. 1 is a perspective view of an assembled juice-extracting container 100. FIG. 2 is a front view of container 100, FIG. 3 is a left-side view of container 100, FIG. 4 is a top view of container 100, and FIG. 5 is a left-side view of container 100 shown disassembled to better illustrate the elements thereof.

Container 100 includes a base container 505 including a first threaded opening 510, a juicer 515 sized to fit within opening 510, and a main closure 520 having a second threaded portion for engaging with the first threaded opening 510. Element 505 through element 520 define a basic configuration for preferred embodiments of the present invention.

Base container 505 is a generally upright cylindrical shell having a longitudinal axis about which there is generally two-dimensional symmetry. Part of the shell near a “top” includes opening 510 having a mechanism for forming a fluidic seal with main closure 520. In the preferred embodiment this includes a threaded portion that mates with a complementary threaded portion of main closure 520.

Juicer 515 may have a wide-variety of configurations as well-known in the arts pertaining to citrus juicers and the like, particularly adapted as described herein. The embodiments of the present invention do not necessarily describe direct improvements in the configuration and operation of a discrete juicer, however many different types of juicers may be advantageously employed in the preferred embodiments to achieve the new and useful configurations described herein.

At a basic configuration, juicer 515 includes one or more juicing elements (e.g., a plurality of ridges and furrows disposed generally parallel to the longitudinal axis of base container 505). These juicing elements extract a quantity of juice from an object (e.g., a lemon, an orange, or other citrus fruit or the like) when interacting with these juicing elements. The interaction, in the preferred embodiment, is direct manipulation of the object against the juicing elements, typically manual manipulation though other juicing techniques are known and may be adapted depending upon implementation and design requirements. Juicer 515 further includes, at a minimum, one or more apertures that communicate the extracted quantity of juice into base container 505.

The basic operation of container 100 includes removing main closure 520 from base container 505 to reveal juicer 515 automatically configured for juicing operation. The user simply extracts the desired quantity of juice from the object into base container 505 by operating juicer 515. The user may stop extracting at any time and place main closure onto base container 505 while juicer 515 is configured in a juice-extracting mode. Main closure 520 holds juicer 515 in place when main closure 520 engages base container 505 and forms the fluidic seal.

Further structures are used, and other operational steps employed, specific to details of the implementation and use for container 100.

FIG. 1 through FIG. 5 illustrate a beverage forming/dispensing implementation for container 100. In furtherance of this implementation, main closure 520 is formed having a secondary closure system including a second opening 525 and a secondary closure 530.

The secondary closure system also forms a fluidic seal inhibiting discharge of fluid from container 100 when both closures are sealed. Preferably, secondary closure is easily manipulated, and includes a conventional screw cap opening as part of second opening 525 and a complementary screw cap as part of secondary closure 530.

Operation is dependent upon the type of beverage to be formed/dispensed. There are many types of juice-enhanced beverages, from 100% “pure” juice beverages to beverages having a small percentage of “pure” juice. When other non-pure juice components are part of the desired beverage, the user opens container 100 by removing closure 520. Juicer 515 may be removed at some portion as necessary or desirable to add one or more beverage elements directly into base container 505. These beverage elements may include one or more additional fluids that are flat or effervescent, other plant components (juices, extracts, emulsions, mixtures, suspensions, and the like), other flavorings, vitamins, dietary supplements, medicines, and the like. Juicer 515 permits the desired quantity of pure fresh juice to be added on-demand whenever the user desires. When the desired beverage components are assembled in base container 505, juicer 515 is returned to position if it had been removed and closure 520 seals container 100. The user may use the secondary closure system to add desired quantities of some beverage components as necessary or desired. For example, the user removes the screw cap 530 and directs a stream of water into container 100 through second opening 525 to fill base container 505 to a desired level/produce a desired ratio of other beverage components.

Second opening 525 is also provided to enable simple extraction of the beverage from container 100. The user simply removes just screw cap 530 to reveal the second opening 525 and may drink the beverage directly from opening 525 or pour the beverage from container 100 into a drinking container or other dispensing system. A user desiring a simple lemon-infused water beverage may use juicer 515 to add a desired quantity from as many lemons as desired. The user closes container 100, unscrews cap 530 and directs a stream of water into container 100 until the desired dilution is reached. Container is resealed by screwing the screw cap back on. Thereafter the user may simply unscrew the cap and treat themselves to a beverage infused with the desired amount of fresh lemon juice. Of course, other juices, closure systems, and beverage components may be used.

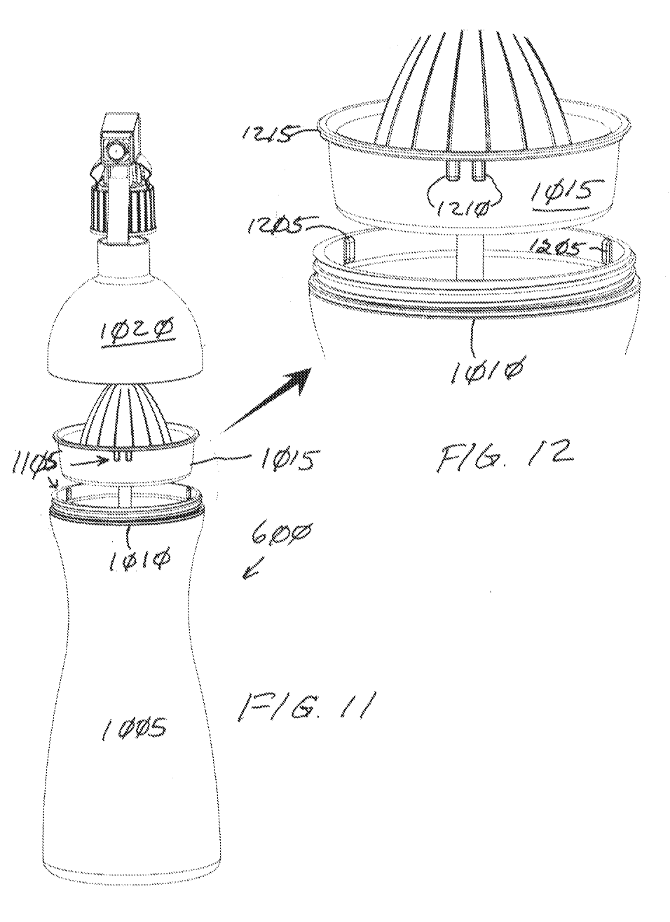

FIG. 6 is a perspective view of an assembled juice-extracting and solution dispensing container 600. FIG. 7 is a front view of container 600, FIG. 8 is a left-side view of container 600, FIG. 9 is a top view of container 600, and FIG. 10 is a left-side view of container 600 shown disassembled to better illustrate the elements thereof.

Container 600 includes a base container 1005 including a first threaded opening 1010, a juicer 1015 sized to fit within opening 1010, and a main closure 1020 having a second threaded portion for engaging with the first threaded opening 1010. Element 1005 through element 1020 define a basic configuration for preferred embodiments of the present invention as described above in FIG. 1 through FIG. 5 with respect to container 100 and elements 505 through 520. Similarly, further structures are used, and other operational steps employed, specific to details of the implementation and use for container 600.

FIG. 6 through FIG. 10 illustrate a cleaning solution forming/dispensing implementation for container 600. In furtherance of this implementation, main closure 1020 is formed having a secondary closure system including a second opening 1025 and a secondary closure 1030 that incorporates a spray head/nozzle. In this configuration, juicer 1015 incorporates an extraction aperture 1035 permitting a conduit 1040 (e.g., a plastic tube) to extend from spray head 1030 into base container 1005. Operation of spray head 1030 permits the fresh-juice-enhanced cleaning solution in base container 1005 to be dispensed in conventional way through conduit 1040.

The secondary closure system also forms a fluidic seal inhibiting discharge of fluid from container 600 when both closures are sealed. Preferably, secondary closure is easily manipulated, and includes a conventional screw-cap-type opening as part of second opening 1025 and a complementary mating spray head/nozzle with attachment screw cap as part of secondary closure 1030.

Operation is dependent upon the type of cleaning solution to be formed/dispensed. There are many types of juice-enhanced cleaning solutions many having juice-enhanced solutions with varying percentages of “pure” juice. The user opens container 600 by removing closure 1020 and pulling conduit 1040 out of aperture 1035 to permit unobstructed operation of juicer 1015. Juicer 1015 may be removed at some portion as necessary or desirable to add one or more cleaning solution elements directly into base container 1005. These cleaning solution elements may include many different types of additional fluids, additives, solvents, scents, and the like. Juicer 1015 permits the desired quantity of pure fresh juice to be added on-demand whenever the user desires. When the desired cleaning solution components are assembled in base container 1005, juicer 1015 is returned to position if it had been removed, conduit 1040 is replaced into base container 1005 through aperture 1035, and closure 1020 seals container 600. In some cases, the user may use the secondary closure system to add desired quantities of some cleaning solution components as necessary or desired. For example, the user removes the spray head 1030 and directs a stream of water or cleaning fluid into container 600 through second opening 1025 to fill base container 1005 to a desired level/produce a desired ratio of other cleaning solution components.

Spray head 1035 is also provided to enable simple dispensation (e.g., spraying) of the fresh-juice-enhanced cleaning solution from container 600. The user simply operates spray head 1030 in conventional manner to produce a stream and directs the stream of cleaning solution directly from spray head 1035 onto a sponge or directly onto a surface to be cleaned.

FIG. 11 is a partial perspective view illustrating an interlock assembly 1105 for a juicer element 1015 such as shown in FIG. 10; and FIG. 12 is an exploded view detailing interlock assembly 1105 of FIG. 11 including a set of first interlocking elements 1205 and one or more second interlocking elements 1210. Preferably, an outer wall of juicer 1015 includes a pair of integrated spaced-apart pins forming each second interlocking element. Disposed inside opening 1010 are one or more mating pins forming the set of first interlocking elements. The spaced-apart pins have a gap about equal to a width of the mating pins, a mating pin of one set of first interlocking elements 1205 is designed to slide between the pair of the spaced-apart pins of the second interlocking elements 1210 when juicer 1015 is slid into place inside opening 1010. Juicer 1015 is also shown as having a lip 1215 overlying a top of opening 1010 when juicer 1015 is installed. Juicer 1015, inside opening 1010, is thereby at least partially sealed when closure 1020 engages the threaded portion on the “outside” of opening 1010. Placement of the mating pin inside the spaced-apart pins prevents juicer 1015 from rotating when juicer 1015 is operated. Some implementations may not require an interlock system while others may implement the interlocking in different fashion.

The preceding describes a container that facilitates addition of on-demand juice into the container without modal conversion of the container to activate a juicing accessory. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

1. (canceled)

2. A juicer-enabled container, comprising:
a base container having a closed surface wherein a portion of said closed surface defines an opening;
a juicer adapted to engage said portion of said closed surface, said juicer including one or more juicing elements that extract a quantity of juice from an object interacting with said one or more juicing elements and further including one or more apertures communicating said quantity of juice into said base container; and
a first closure, repeatedly engageable with and disengageable from said portion of said closed surface, sealing said opening while said juicer is engaged with said portion of said closed surface and while said juicer is engaged in a juice-extracting configuration wherein said juicer includes an extraction aperture and wherein said first closure includes a sprayer head having a conduit extending from said sprayer head through said extraction aperture and into said base container.

3. (canceled)

4. The container of claim 2 wherein said portion of said closed surface includes a first component of an interlock and wherein said juicer includes a second component of said interlock interoperable with said first component restricting motion of said juicer when said object interacts with said one or more juicing elements.

5-6. (canceled)

7. A juicing method, the method comprising the steps of:
(a) disengaging a first closure from a portion of a surface of a container, said portion of said surface defining an opening, wherein said first closure disengaging step reveals a juicer engaged with said portion of said surface with said juicer overlaying a reservoir of said container and said revealed juicer preconfigured into a juice-extracting configuration automatically available for juicing without reconfiguring said juicer; and
(b) interacting an object with said juicer to extract juice into said reservoir;
(c) communicating a conduit coupled to a sprayer head into said reservoir through an extraction aperture provided in said juicer; and
(d) operating said sprayer head to spray said extracted juice from said reservoir.

8. A juice-extracting container, comprising:
a base container enclosing a container volume accessible through a container opening with said container opening provided with a first mating structure;
a discrete juicer removeably disposed within said container opening in a juicing arrangement configured to extract juice from an object into said container volume without a modal conversion of said discrete juicer to activate a juicing arrangement; and
a main closure enclosing an enclosure volume accessible through a main closure opening, said main closure opening complementary to said container opening and including a second mating structure selectively engageable with and disengageable from said first mating structure while said discrete juicer is disposed in said container opening in said juicing configuration, said second mating structure forming a fluidic seal with said first mating structure when selectively engaged therewith retaining a fluid within a combined volume that includes said container volume and said enclosure volume;
wherein said first mating structure includes a container screw thread disposed at said container opening and wherein said second mating structure includes a first closure screw thread complementary to said container screw thread; and
a secondary closure system in fluid communication with said combined volume, said secondary closure system including a removable and replaceable cap provided with a cap mating structure and a secondary closure opening accessing said combined volume, said secondary closure opening complementary to said removable and replaceable cap and including a secondary mating structure with said removable and replaceable cap selectively engageable with and disengageable from said secondary mating structure while said discrete juicer is disposed in said container opening in said juicing configuration, said secondary mating structure forming a fluidic seal with said cap mating structure when selectively engaged therewith retaining said fluid within said combined volume.

9. (canceled)

10. The juice-extracting container of claim 8 wherein said base container includes a shell having a container longitudinal axis extending from a distal end to a proximal end, said shell including a container base at said distal end, said container opening at said proximal end, and a sidewall coupled to said base and extending to said opening.

11. The juice-extracting container of claim 10 wherein said sidewall includes two-dimensional symmetry about said container longitudinal axis.

12. (canceled)

13. The juice-extracting container of claim 8 wherein an inside surface of said container opening has a perimeter shape and wherein said discrete juicer includes a juicer base having an exterior perimeter complementary to said perimeter shape and removeably retained at said container opening with said juicer base including a juice aperture communicated into said container volume, said discrete juicer further including a plurality of juicer elements coupled to said juicer base and extending away from said container opening.

14. The juice-extracting container of claim 13 wherein said discrete juicer includes a juicer longitudinal axis extending from said juicer base generally co-axial with said container longitudinal axis.

15. (canceled)

16. The juice-extracting container of claim 8 wherein said cap mating structure includes a cap screw thread and wherein said secondary mating structure includes a secondary closure screw thread complementary to said cap screw thread.

17. The juice-extracting container of claim 8 wherein said secondary closure system is disposed in said main closure.

18. The juice-extracting container of claim 17 wherein said main closure includes a main closure longitudinal axis extending from said main closure opening to a main closure terminus, said main closure longitudinal axis generally coaxial with said container longitudinal axis and wherein said secondary closure system is disposed at said terminus and includes a secondary closure longitudinal axis generally co-axial with said main closure longitudinal axis, said secondary closure longitudinal axis passing through said secondary closure opening.

19. A juice-extracting container, comprising:
a base container enclosing a container volume accessible through a container opening with said container opening provided with a first mating structure;
a discrete juicer removeably disposed within said container opening in a juicing arrangement configured to extract juice from an object into said container volume; and
a main closure enclosing an enclosure volume accessible through a main closure opening, said main closure opening complementary to said container opening and including a second mating structure selectively engageable with and disengageable from said first mating structure while said discrete juicer is disposed in said container opening in said juicing configuration, said second mating structure forming a fluidic seal with said first mating structure when selectively engaged therewith retaining a fluid within a combined volume that includes said container volume and said enclosure volume and further comprising a sprayer system in fluid communication with said combined volume, said sprayer system including a sprayer head coupled to said main closure and a conduit extending from said sprayer head into said container volume.

20. The juice-extracting container of claim 19 wherein an inside surface of said container opening has a perimeter shape and wherein said discrete juicer includes a generally planar juicer base having an exterior perimeter complementary to said perimeter shape and removeably retained at said container opening with said juicer base including a juice aperture communicated into said container volume, said discrete juicer further including a plurality of juicer elements coupled to said generally planar juicer base and extending away from said generally planar juicer base and joined together at a juicer apex with said juicer apex including a conduit aperture, further comprising a sprayer system in fluid communication with said combined volume, said sprayer system including a sprayer head coupled to said main closure and a conduit extending from said sprayer head into said container volume through said conduit aperture.

21. A juice-extracting container, comprising:
a base container enclosing a container volume accessible through a container opening with said container opening provided with a first mating structure;
a discrete juicer removeably disposed within said container opening in a juicing arrangement configured to extract juice from an object into said container volume; and
a main closure enclosing an enclosure volume accessible through a main closure opening, said main closure opening complementary to said container opening and including a second mating structure selectively engageable with and disengageable from said first mating structure while said discrete juicer is disposed in said container opening in said juicing configuration, said second mating structure forming a fluidic seal with said first mating structure when selectively engaged therewith retaining a fluid within a combined volume that includes said container volume and said enclosure volume;
further comprising a secondary closure system in fluid communication with said combined volume, said secondary closure system including a removable and replaceable cap provided with a cap mating structure and a secondary closure opening accessing said combined volume, said secondary closure opening complementary to said removable and replaceable cap and including a secondary mating structure with said removable and replaceable cap selectively engageable with and disengageable from said secondary mating structure while said discrete juicer is disposed in said container opening in said juicing configuration, said secondary mating structure forming a fluidic seal with said cap mating structure when selectively engaged therewith retaining said fluid within said combined volume;
wherein said secondary closure system is disposed in said main closure;
wherein said main closure includes a main closure longitudinal axis extending from said main closure opening to a main closure terminus, said main closure longitudinal axis generally coaxial with said container longitudinal axis and wherein said secondary closure system is disposed at said terminus and includes a secondary closure longitudinal axis generally co-axial with said main closure longitudinal axis, said secondary closure longitudinal axis passing through said secondary closure opening; and
further comprising a sprayer system in fluid communication with said combined volume, said sprayer system including a sprayer head coupled to said secondary closure and a conduit extending from said sprayer head into said container volume.

22. The juice-extracting container of claim 21 wherein an inside surface of said container opening has a perimeter shape and wherein said discrete juicer includes a generally planar juicer base having an exterior perimeter complementary to said perimeter shape and removeably retained at said container opening with said juicer base including a juice aperture communicated into said container volume, said discrete juicer further including a plurality of juicer elements coupled to said generally planar juicer base and extending away from said generally planar juicer base and joined together at a juicer apex with said juicer apex including an extraction aperture, further comprising a sprayer system in fluid communication with said combined volume, said sprayer system including a sprayer head coupled to said main closure and a conduit extending from said sprayer head into said container volume through said extraction aperture.

23. (canceled)

24. A juicing method, the method comprising the steps of:
(a) disengaging a first closure from a portion of a surface of a container, said portion of said surface defining an opening, wherein said first closure disengaging step reveals a juicer engaged with said portion of said surface with said juicer overlaying a reservoir of said container and said revealed juicer preconfigured into a juice-extracting configuration automatically available for juicing without reconfiguring said juicer; and
(b) interacting an object with said juicer to extract juice into said reservoir;
(c) reengaging, after step (b) said first closure to said portion of said surface of said container while said juicer is engaged with said portion of said surface with said juicer overlaying a reservoir of said container and preconfigured into said juice-extracting configuration
(d) communicating a conduit coupled to a sprayer head into said reservoir through an extraction aperture provided in said juicer; and
(e) operating said sprayer head to spray said extracted juice from said reservoir.

25. A juice processing method, comprising:
(a) disengaging a main closure from a base container enclosing a container volume accessible through a container opening by unsealing a fluidic seal between said main closure and said base container formed around said container opening;
(b) revealing, after said disengaging step (a), a discrete juicer removeably disposed within said container opening, said discrete juicer in a juicing arrangement configured to extract juice from an object into said container volume when revealed without a modal conversion of said discrete juicer to activate a juicing arrangement;
(c) extracting, using said discrete juicer disposed within said container opening in said juicing arrangement as revealed by revealing step (b), a quantity of juice from a juice-containing object; and thereafter
(d) directing said quantity of juice into said container volume using said discrete juicer; and thereafter
(e) reengaging said main closure with said base container without reconfiguring said discrete juicer within said container opening, said reengaging step (e) forming said fluidic seal between said main closure and said base container around said container opening; and thereafter
(f) disengaging a replaceable cap of a secondary closure system in fluid communication with said container volume through said discrete juicer, said secondary closure system including said replaceable cap provided with a cap mating structure and a secondary closure opening accessing said container volume, said secondary closure opening complementary to said replaceable cap and including a secondary mating structure with said replaceable cap selectively engageable with and disengageable from said secondary mating structure while said discrete juicer is disposed in said container opening in said juicing configuration, said secondary mating structure forming a fluidic seal with said cap mating structure when selectively engaged therewith retaining said fluid within said container volume;
(g) extracting juice from said container volume through said secondary closure opening and said discrete juicer while said replaceable cap is removed.

26-30. (canceled)

31. A juice processing method, comprising:
(a) disengaging a main closure from a base container enclosing a container volume accessible through a container opening by unsealing a fluidic seal between said main closure and said base container formed around said container opening;
(b) revealing, after said disengaging step (a), a discrete juicer removeably disposed within said container opening, said discrete juicer in a juicing arrangement configured to extract juice from an object into said container volume when revealed;
(c) extracting, using said discrete juicer disposed within said container opening in said juicing arrangement as revealed by revealing step (b), a quantity of juice from a juice-containing object; and thereafter
(d) directing said quantity of juice into said container volume using said discrete juicer; and thereafter
(e) reengaging said main closure with said base container without reconfiguring said discrete juicer within said container opening, said reengaging step (e) forming said fluidic seal between said main closure and said base container around said container opening;
(f) solutionizing said quantity of juice within said container volume with addition of one or more cleaning components into said container volume along with said quantity of juice to produce a cleaning solution while said main closure is engaged with said base container and said discrete juicer is disposed within said container opening in said juicing arrangement wherein one of said cleaning components includes a cleaning fluid; wherein said solutionizing step (f) further includes:
(f1) disengaging a secondary closure from a structure defining a secondary opening in fluid communication with said container volume while said main enclosure is engaged with and fluidically sealed to said base container and said discrete juicer is removeably disposed within said container opening and in said juicing arrangement, said secondary closure fluidically sealing said secondary opening when said secondary closure engages said structure wherein said secondary closure includes a sprayer head coupled to a conduit;
(f2) revealing said secondary opening; and
(f3) streaming said cleaning fluid into said container volume through said secondary opening while said main enclosure is engaged with and fluidically sealed to said base container and said discrete juicer is removeably disposed within said container opening;
(g) reengaging said secondary closure to said structure after said solutionizing step (f) and forming said fluidic seal between said secondary closure and said structure while extending said conduit into said base volume; and thereafter
(h) dispensing said cleaning solution from said container volume using said sprayer head while said main enclosure is engaged with and fluidically sealed to said base container and said discrete juicer is removeably disposed within said container opening in said juicing arrangement.
